(19) United States
(12) Patent Application Publication
(10) Pub. No.: US 2016/0299054 A1
(43) Pub. Date: Oct. 13, 2016

(54) A METHOD AND DEVICE FOR FATIGUE TESTING OF PHOTOCHROMIC, FLUORESCENT OR PHOSPHORESCENT DYE/DYES, OR OF A MIXTURE OF AT LEAST TWO OF THEM, AND A DEVICE FOR CARRYING OUT THIS METHOD

(71) Applicant: Technicka univerzita v Liberci, Liberec (CZ)

(72) Inventors: Michal VIK, Liberec (CZ); Martina VIKOVA, Liberec (CZ)

(21) Appl. No.: 15/100,604

(22) PCT Filed: Dec. 2, 2014
(86) PCT No.: PCT/CZ2014/000144

§ 371 Date: May 31, 2016

(30) Foreign Application Priority Data
Dec. 3, 2013 (CZ) PV 2013-959

(51) Int. Cl. G01N 17/00; G01J 3/50; G01N 21/64

(52) U.S. Cl. CPC G01N 17/004; G01N 21/6428; G01J 3/50; G01N 2201/08; G01N 2201/061

(57) ABSTRACT

A method and a device for fatigue testing of photochromic, fluorescent or phosphorescent dye/dyes or of a mixture of at least two of them, in which a sample (3) containing photochromic, fluorescent or phosphorescent dye/dyes or a mixture of at least two of them is exposed to a predetermined number of cycles of luminous exposure to an excitation light beam (81), which evokes a color response of the photochromic, fluorescent or phosphorescent dye/dyes or of the mixture of at least two of them in the sample (3). Before and/or during and/or after each predetermined exposure to the excitation light beam (81), the sample (3) containing the photochromic, fluorescent or phosphorescent dye/dyes or of the mixture of at least two of them is exposed at least once to irradiation by an exposure light beam (71), due to which the dye/dyes is/are subject to fatigue loading. Simultaneously, a measuring light beam (41) is introduced to the sample (3) and is reflected from it, whereby the change and/or the course of the change in the characteristics of the measuring light beam (41) reflected from the sample is monitored by a spectrometer (94). From this change and/or the course of the change it is possible to deduce the course of the color response and/or the change in the color response of the particular photochromic, fluorescent or phosphorescent dye/dyes or of the mixture of at least two of them in the sample (3) to the exposure to an excitation light beam (81) and thus it is possible to deduce the fatigue of this photochromic, fluorescent or phosphorescent dye/dyes or of the mixture of at least two of them.

### TECHNICAL FIELD

The invention relates to a method for fatigue testing of photochromic, fluorescent or phosphorescent dye/dyes or of a mixture of at least two of them.

The invention further relates to a device for carrying out this method.

### BACKGROUND ART

For monitoring changes in different characteristics of different materials as a result of long-term fatigue stress, the so-called accelerated ageing tests are currently used, in which long-term impact of external conditions/factors is simulated in a relatively short time by exposing the particular materials to these conditions/factors cyclically with intensified influence (such as higher intensities of radiation, higher temperatures, increased concentrations of ozone, etc.). After carrying out a predetermined number of cycles, changes in the characteristics of the materials or changes in their responses to a particular external condition/factor are monitored and evaluated. These tests include, for example, also tests of color fastness of textile dyes under exposure to light in accordance with the CSN (Czech Technical Standard) EN ISO 105-B04 “Textiles—Tests for color fastness—Part B04: Color fastness to artificial weathering: Xenon arc fading lamp test” and CSN (Czech Technical Standard) EN ISO 105-B06 “Textiles—Tests for color fastness—Part B06: Color fastness and ageing at artificial light at high temperatures: Xenon arc fading lamp test”. However, their disadvantage consists in that they cannot be used for fatigue testing of photochromic, fluorescent or phosphorescent dye/dyes or their mixture, since in the case of these dyes, these tests lead to an incorrect conclusion about their low color fastness. This is caused primarily by the fact that during the exposure of most photochromic dyes to intense artificial light, a triplet-triplet excitation occurs relatively quickly, followed by degradation of their chromic system, resulting in their bleaching.

For these reasons, several new methods and devices have been developed for fatigue testing of photochromic, fluorescent or phosphorescent dye/dyes or of their mixture, which are based on using a light source having an output and intensity which closely match the characteristics of natural daylight. Nevertheless, their disadvantage lies in the fact that they take place in a discontinuous way and are therefore rather time-consuming. Also, the technical equipment used, especially the light source, as well as the manner of its operation, when the monitored sample is lit by short flashes of light, do not allow illumination to pass through the entire sample properly, and so initially the response of the monitored dye/dyes occurs only in a thin layer on the surface of the sample, which is another drawback. Due to this, several initial responses or rather several tens of initial responses of the dye/dyes are significantly distorted.

The goal of the invention is to devise a method for fatigue testing of photochromic, fluorescent or phosphorescent dye/dyes or of a mixture of at least two of them, which would eliminate the disadvantages of the background art and enable reliable testing of this/these dye/dyes from the very beginning of the test.

The aim of the invention is also to provide a device for carrying out this method.

PRINCIPLE OF THE INVENTION

The goal of the invention is achieved by a method for fatigue testing of photochromic, fluorescent or phosphorescent dye/dyes or of a mixture of at least two of them, whose principle consists in that a sample containing photochromic, fluorescent or phosphorescent dye/dyes or a mixture of at least two of them is exposed to a predetermined number of cycles of luminous exposure to an excitation light beam, which evokes a color response of the photochromic, fluorescent or phosphorescent dye/dyes or of the mixture of at least two of them in the sample, whereby before and/or during and/or after each predetermined exposure to the excitation light beam, the sample containing photochromic, fluorescent or phosphorescent dye/dyes, or of the mixture of at least two of them is exposed at least once to the exposure light beam, due to which the dye/dyes is/are subject to fatigue loading. Simultaneously, a measuring light beam is introduced to the sample and is then reflected from it, whereby the change and/or the course of the change in the characteristics of the measuring light beam reflected from the sample is monitored by a spectrometer and from this change and/or the course of the change it is possible to deduce the course of the color response and/or the change in the color response of the particular photochromic, fluorescent or phosphorescent dye/dyes or of the mixture of at least two of them to the exposure to the excitation light beam, and, consequently, it is possible to deduce the fatigue of this/these photochromic, fluorescent or phosphorescent dye/dyes, or of the mixture of at least two of them.

The exposure light beam simulates advantageously natural daylight.

In addition to that, the goal of the invention is also achieved by a device for fatigue testing of photochromic, fluorescent or phosphorescent dye/dyes, or of a mixture of at least two of them, whose principle consists in that it contains a spherical optical integrator, in which a measuring aperture, an inlet aperture of the measuring light beam, an inlet aperture of the exposure and excitation light beams and an outlet aperture of the measuring light beam are formed. Moreover, in the vicinity of the measuring aperture, outside the optical integrator, is arranged space for storing and fixing the sample containing the tested photochromic, fluorescent or phosphorescent dye/dyes, or the mixture of at least two of them. Outside the optical integrator, the inlet aperture of the measuring light beam is aligned with a source of the measuring light beam, whereby a filter of luminous radiation having an excitation wavelength, as well as a filter of infrared radiation, are positioned in the path of the measuring light beam. To the inlet aperture of the exposure and excitation light beams is outside the optical integrator assigned a path of the exposure light beam containing a source of the exposure light beam, and a path of the excitation light beam containing a source of the excitation light beam. Moreover, both these paths have a common portion containing a beam splitter arranged in an inverse arrangement, a chopper and mirror optics for introducing the exposure and excitation light beams into the inner space of the optical integrator, whereby the path of the exposure light beam contains a shutter of the exposure light beam, whereas the path of the excitation light beam contains a shutter of the excitation light beam and a monochromator. To the outlet aperture of the measuring light beam is outside the optical integrator assigned a path of the measuring light beam containing a spectrometer. The path contains a chopper and mirror optics for introducing the measuring light beam into the sensing space of the spectrometer.

It is also advantageous if the path of the exposure beam includes at least one correction filter which serves to filter off certain irrelevant or ballast components of the exposure light beam and to approximate the character of this beam to the character of light according to the required conditions of testing, for example, to natural daylight at particular times of the day, etc.

So as to obtain more accurate results, it is advantageous if the path of the measuring light beam includes an objective which serves to focus on the active spot of the sample where the response of its dye/dyes takes place and/or to adjust the size of the area of the sample that is being sensed by the spectrometer.

In order to achieve the required excitation of the color change in the photochromic, fluorescent or phosphorescent dye/dyes or the mixture of at least two of them, as well as the fatigue loading of the sample by the exposure light beam, in a manner that is as accurate as possible, it is advantageous if the chopper in the common part of the path of the exposure and excitation light beams and the chopper in the path of the measuring light beam are interconnected by a time bond. For the same reason, it is also favourable if the shutter of the exposure light beam is provided with a time lock and is interconnected with the shutter of the excitation light beam by a time bond.

So as to be able to monitor the influence of the temperature on the fatigue testing of the photochromic and/or fluorescent and/or phosphorescent dye/dyes, or, on the contrary, to exclude completely the influence of the temperature or its change from the fatigue testing, all the parts of the device for the fatigue testing of the photochromic, fluorescent or phosphorescent dye/dyes, or at least the space for storing and fixing the sample, are mounted in a thermostatic box. Preferably, a thermostatic head is also mounted in the vicinity of the space for storing and fixing the sample, controlling the temperature of this space and of the sample stored in it and, should the need arise, amending the temperature as well.

Furthermore, any part of the path of the exposure light beam and/or that of the excitation light beam and/or that of the measuring light beam can consist of an optical fiber/optical fibers.

In order to avoid the so-called drift of the luminous sources, the device for fatigue testing of photochromic, fluorescent or phosphorescent dye/dyes, or of a mixture of at least two of them, according to the invention, is preferably designed as a two-beam device, which means that it is provided with an unillustrated source of a reference light beam, with which is aligned a reference spectrometer which measures the reflection of the reference light beam from the constant reference sample having a known value of absolute reflectance, which is a white standard or, for example, a part of the white inner surface of the optical integrator.

### DESCRIPTION OF DRAWINGS

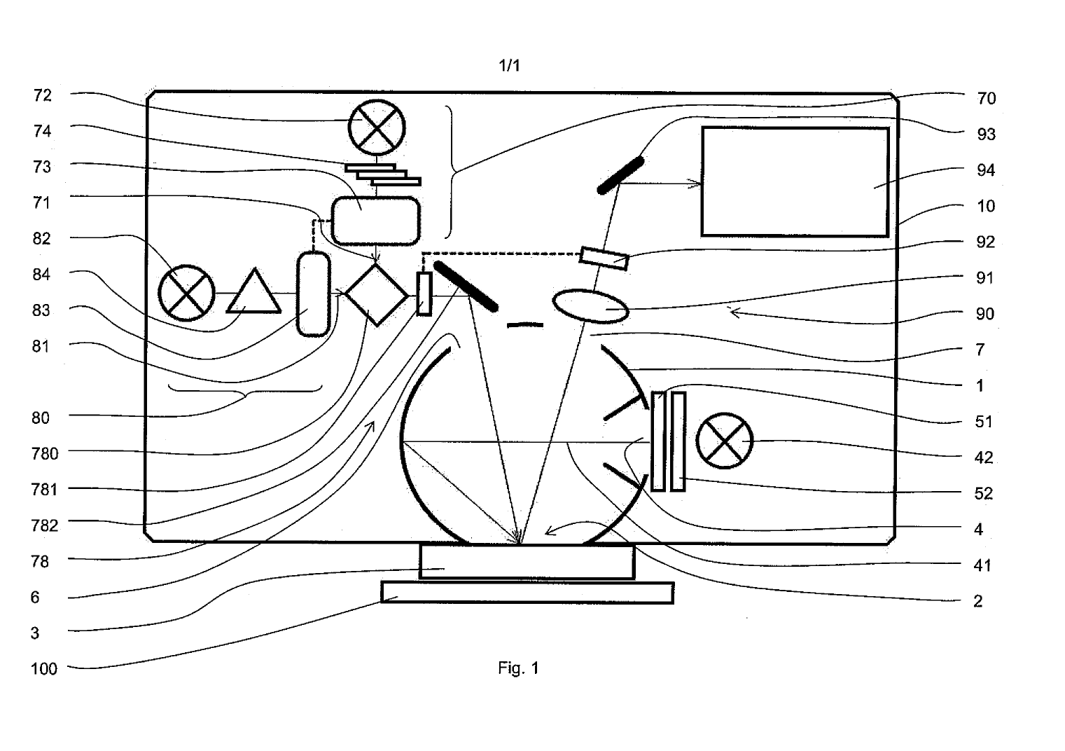

In the enclosed drawing, FIG. 1 shows a diagram of one variant of a device for carrying out fatigue testing of photochromic, fluorescent or phosphorescent dye/dyes, or of a mixture of at least two of them according to the invention.

### EXAMPLE OF EMBODIMENT

A method for fatigue testing of photochromic, fluorescent or phosphorescent dye/dyes or of a mixture of at least two of them according to the invention will be explained using a concrete variant of a device for carrying out this method, shown in FIG. 1. However, this variant is just one among a number of possible alternatives of embodiment of this device, whereby other alternatives of embodiment may differ from this variant, for example the spatial arrangement of individual elements may vary, as well as the method for transmission/link of the excitation and/or exposure and/or measuring light beam, whereby any of the beams may be at least on part of its path transmitted/carried, for example, through an optical fiber/optical fibers, or using any other known method, etc.

A device for fatigue testing of photochromic, fluorescent or phosphorescent dye/dyes or of a mixture of at least two of them according to the invention, shown in FIG. 1, contains an optical integrator 1 of a spherical shape. This optical integrator 1, due to the material from which it is made and/or due to its surface finish, such as a coat of paint, is impermeable to light radiation, and therefore it prevents ambient light penetration into the inner space, thus excluding its influence on the course of the fatigue testing of the particular photochromic, fluorescent or phosphorescent dye/dyes or the mixture of at least two of them, prevents the excitation, exposure and measuring light beams, which are introduced to the inner space in a controlled manner, from dispersing into the ambient surroundings, and at the same time enables to measure the intensity of the luminous radiation reflected independently of the direction taken by the radiation after being reflected.

A measuring aperture 2 is formed in the lower portion of the optical integrator 1. In its close vicinity, outside the optical integrator 1, is arranged unillustrated space for storing and fixing the sample 3 containing the tested photochromic, fluorescent or phosphorescent dye/dyes or the mixture of at least two of them. The sample 3 is, for example, a textile, but substantially any material could be used, and the dye being tested is any photochromic, fluorescent or phosphorescent dye/dyes or a mixture of at least two of them, which is sensitive, for example, to UV radiation.

Above the measuring aperture 2, in the central portion of the optical integrator 1, is formed an inlet aperture 4 of a measuring light beam 41, with which is outside the optical integrator 1 aligned a source 42 of this measuring light beam 41. In the path of the measuring light beam 41 is arranged a filter 51 of luminous radiation having an excitation wavelength, which is in this particular case UV radiation, and a filter 52 of IR radiation, due to which the measuring light beam 41 does not cause the excitation of the photochromic, fluorescent or phosphorescent dye/dyes or of the mixture of at least two of them in the sample 3, nor does it contribute to it in any manner. It does not heat the inner space of the optical integrator 1 and/or the sample 3 either.

An inlet aperture 6 of the excitation and of the exposure light beams, as well as an outlet aperture 7 of the measuring light beam 41 are formed in the upper portion of the optical integrator 1. To the inlet aperture 6 of the excitation and of the exposure light beams 71, 81 is outside the optical integrator 1 assigned a path 70 of the exposure light beam 71 with a source 72 of the exposure light beam 71, and the path 80 of the excitation light beam 81 with a source 82 of the excitation light beam 81. Furthermore, both these paths 70 and 80 have a common part 78 which contains a beam splitter 780, a chopper 781 and mirror optics 782 and which introduces the exposure and excitation light beams 71, 81 through the inlet aperture 6 into the inner space of the optical integrator 1. The path 70 of the exposure light beam 71 further contains a shutter 73 of the exposure light beam 71 and a correction filter 74/correction filters, assigned to the source 72 of the exposure light beam 71, while the path 80 of the excitation light beam 81 contains a shutter 83 of the excitation light beam 81 and a monochromator 84, assigned to the source 82 of the excitation light beam 81.

The mirror optics 782, comprising a mirror or a system of mirrors, serves to direct the exposure and excitation light beams 71, 81 into the inner space of the optical integrator 1, without decreasing their intensity or changing their characteristics. Moreover, it enables to screen off their IR component, which is vital for achieving the required accuracy of the fatigue testing, since the IR component of any of them could otherwise cause heating the inner space of the optical integrator 1 and/or the sample 3, which could lead at least in the case of some photochromic, fluorescent or phosphorescent dyes to undesired additional excitation or could influence the parameters that are measured.

A chopper 781, which is a synchronous system of periodical blocking the optical path of the beam light, is used to set a cyclic passage of the exposure and/or excitation light beams 71, 81, and thus to control the excitation and reversal phases of the photochromic, fluorescent or phosphorescent dye/dyes, or of the mixture of at least two of them in the sample 3, and its loading by the exposure light beam 71. The chopper 781 can be electronic or mechanical, whereby an advantageous embodiment contains a mechanical chopper 781, which is designed as a divided circular screen which by regulating its revolutions enables to change the period of time during which the light beam, in this particular case the exposure and/or excitation light beams 71, 81, is let through or, on the contrary, blocked.

A beam splitter 780 of any known type, preferably a mirror-type beam splitter, is in the common part 78 of the path of the exposure and excitation light beams 71, 81 arranged inversely, and so it fuses the exposure light beam 71 and the excitation light beam 81 into one exposure-excitation light beam in case of concurrence of these beams.

The shutter 73 of the exposure light beam 71 is used to let through the exposure light beam 71 in a controlled manner. Moreover, this shutter 73 is provided with a time lock, whereby it is interconnected by a time bond (in FIG. 1 it is indicated by a dashed line) with the shutter 83 of the excitation light beam 81, thus enabling to achieve, for example, the required delay of the exposure light beam 71 in relation to the excitation light beam 81, or, optionally, a different predetermined time sequence of these light beams 71, 81, and in this manner to set appropriately the fatigue loading of the photochromic, fluorescent or phosphorescent dye/dyes, or of the mixture of at least two of them in the sample 3 into a suitable phase of its/their response to the excitation beam 81.

The correction filter/filters 74 then serves/serve to filter off certain components of no interest or ballast components of the exposure light beam 71 and to approximate this beam, for example, to the character of natural daylight at particular times of the day, or to the character of another kind of light, according to required conditions of testing. If the character of the exposure light beam 71 meets the requirements of the fatigue testing, the correction filter/filters 74 can be omitted from the construction of the device.

The source 72 of the exposure light beam 71 is a polychromatic light source which simulates (optionally in cooperation with a correction filter/correction filters 74) the required illumination of the sample 3 according to the particular requirements of fatigue testing, for example, natural daylight, etc., and which in this manner serves to carry out fatigue testing of the photochromic, fluorescent or phosphorescent dye/dyes, or of the mixture of at least two of them in the sample 3.

The shutter 83 of the excitation light beam 81 is used to transmit the excitation light beam 81 in a controlled manner according to the needs and the setting of the fatigue testing, and in cooperation with the chopper 781 it is used to control the course of the phase of the color response of the photochromic, fluorescent or phosphorescent dye/dyes or of the mixture of at least two of them in the sample 3.

The monochromator 84 is intended to change/adjust the wavelength of the excitation light beam 81 according to the character of the tested photochromic, fluorescent or phosphorescent dye or their mixture. Using different settings when performing the testing of one sample 3 allows to carry out an analysis of the spectral sensitivity of the particular photochromic, fluorescent or phosphorescent dye/dyes or the mixture of at least two of them.

The source 82 of the excitation light beam 81 is a source of the excitation light beam 82 which evokes the excitation of the photochromic, fluorescent or phosphorescent dye/dyes or of the mixture of at least two of them contained in the sample 3 and its possible color response. The parameters of this source 82 and its excitation light beam 81 depend on the spectral sensitivity of the dye/dyes being tested, whereby, for example, the light source used in the illustrated example of embodiment is a source illuminating materials in the spectrum of UV radiation.

To the outlet aperture 7 of the measuring light beam 41 from the optical integrator 1 is outside the optical integrator 1 assigned a path 90 of the measuring light beam 41 with a spectrometer 94. This path includes an objective 91, a chopper 92 and mirror optics 93. In addition, the outlet aperture 7 of the measuring light beam 41 is provided with an unillustrated elimination aperture which is used for eliminating chromatic aberration.

The objective 93 serves to focus on the active spot of the sample 3, where the color response of its dye/dyes takes place and/or to adjust the size of the area of the sample 3 which is sensed by the spectrometer 94. If the active spot of the sample 3 is sufficiently large and is suitably placed in relation to the outlet aperture 7 of the measuring light beam 41, it is not necessary to use the objective 93. However, if the path of the measuring light beam 41 is composed at least partially of optical fibers, it is always necessary to use the objective 81.

It is advantageous if the chopper 84 is interconnected by a time bond (in FIG. 1 indicated by a dashed line) with a chopper 781 in the common portion 78 of the path of the exposure and excitation light beams 71, 81. At the same time, it can be used for a number of purposes according to the requirements and the course of the test, such as for generating a prismatic signal, which by using Fourier Transform enables to eliminate noise, for synchronizing the signal captured by the spectrometer 94 with the exposure and/or excitation light beam 71, 81, etc., by which means it contributes not only to achieving more accurate results of the fatigue testing and increases possibilities of using them, but also enables to modulate the time of sensing by the spectrometer 94 according to the needs and the character of the tested photochromic, fluorescent or phosphorescent dye/dyes or of the mixture of at least two of them.

The mirror optics 93, composed of a mirror or system of mirrors, serves to direct and concentrate the measuring light beam 41, reflected from the sample 3, into the inner space of the spectrometer 82 without decreasing its intensity or changing its characteristics.

The spectrometer 82, which is a standard spectrometer 82 of any known type, is used for detecting and evaluating spectral data of the tested photochromic, fluorescent or phosphorescent dye/dyes or of the mixture of at least two of them contained in the sample 3 with time dependence.

In order to exclude the so-called drift of the luminous sources, the device for fatigue testing of photochromic, fluorescent or phosphorescent dye/dyes or of a mixture of at least two of them according to the invention is preferably designed as a two-beam device. This means that it includes an unillustrated source of a reference light beam and to it assigned reference spectrometer, which measuries the reflection of the reference light beam from the constant reference sample having a known value of absolute reflectance, which is a white standard or, for example, a part of the white inner surface of the optical integrator.

The device for fatigue testing of photochromic, fluorescent or phosphorescent dye/dyes or of a mixture of at least two of them in the sample 3 is in the illustrated example of embodiment enclosed in a thermostatic box 10, which is equipped with known unillustrated means of regulating the temperature, enabling to set the temperature of the sample 3 and its surroundings. In this manner, the thermostatic box 10 allows to monitor the influence of the temperature on the fatigue testing of photochromic and/or fluorescent and/or phosphorescent dye/dyes, or, on the contrary, to exclude totally the influence of the temperature or its change on the fatigue testing. In other unillustrated examples of embodiment, the thermostatic box can be minimized just for the purpose of storing the sample 3 and, possibly, its closest surroundings, or it is not used at all. In the vicinity of the sample 3, for example below it, as is shown in FIG. 1, a thermostatic head 100 can be mounted for checking and/or controlling the temperature of the sample 3 and its surroundings.

The function of the device for fatigue testing of photochromic, fluorescent or phosphorescent dye/dyes of or a mixture of at least two of them consists in that due to the shutter 73 of the exposure light beam 71, the shutter 83 of the excitation light beam 81, their optional connection by a time bond, and the chopper 781, the dye being tested is exposed cyclically according to predetermined requirements to luminous exposure , the particular dye is subject to fatigue loading at least by one luminous exposure or a cycle of exposures to the exposure light beam 71, which simulates, for example, natural daylight, or some other light, as is required. The exposure and excitation light beams 71, 81 can be introduced into the inner space of the optical integrator 1 gradually in any time sequence (it is advantageous if the excitation light beam 81 is introduced first), or they can be made into one exposure-excitation beam.

Simultaneously, the measuring light beam 41 is also introduced into the inner space of the optical integrator. It is then introduced onto the sample 3 by being reflected from the inner wall of the optical integrator 1 and being reflected from the sample 3 it is carried onto the mirror optics 93 into the sensing space of the spectrometer 94 through the objective 91 and the chopper 92. At the same time, the spectrometer 94 detects and records the characteristics of the measuring light beam 41, or their change and/or the course of their change. The color response of the tested photochromic, fluorescent or phosphorescent dye/dyes or of the mixture of at least two of them causes the change of the characteristics of the measuring light beam 41, whereby other changes in its characteristics are also caused by possible fatigue of the tested dye/dyes, the change of color response being connected to it. The data set obtained by the spectrometer 94 then according to the requirements and setting of the device illustrates the course of the color response, or, for example, only some of its phases during the fatigue loading of the particular photochromic, fluorescent or phosphorescent dye/dyes or the mixture of at least two of them, and so from this change and/or course of the change it is possible to deduce the course of the color response and/or the change in the color response of the particular photochromic, fluorescent or phosphorescent dye/dyes, or of the mixture of at least two of them in the sample 3 as a result of its exposure by the excitation light beam 81, and thus the fatigue of the photochromic, fluorescent or phosphorescent dye/dyes, or of the mixture of at least two of them.

Furthermore, the cycles of fatigue loading by the exposure light beam 71 and/or by cycles of excitation of the color response by the excitation light beam 81 can be regular or irregular according to the requirements and can be set substantially in any mutual relation, as will be needed.

Also, this method for fatigue testing of photochromic, fluorescent or phosphorescent dye/dyes or of a mixture of at least two of them can take place in a continuous manner during any predetermined period of time.

### LIST OF REFERENCES

1 optical integrator
2 measuring aperture
3 sample
4 inlet aperture of the measuring light beam
41 measuring light beam
42 source of the measuring light beam
51 filter of luminous radiation having an excitation wavelength
52 filter of IR radiation
6 inlet aperture of the exposure and excitation light beams
7 outlet aperture of the measuring light beam
70 path of the exposure light beam
71 exposure light beam
72 source of the exposure light beam
73 shutter of the exposure light beam
74 correction filter
78 common part of the path of the exposure and the path of the excitation light beam
780 beam splitter
781 chopper
782 mirror optics
80 path of the excitation light beam
81 excitation light beam
82 source of the excitation light beam
83 shutter of the excitation light beam
84 monochromator
90 path of the measuring light beam
91 objective
92 chopper
93 mirror optics
94 spectrometer
10 thermostatic box
100 thermostatic head

1. A method for fatigue testing of photochromic, fluorescent or phosphorescent dye/dyes or of a mixture of at least two of them, wherein a sample containing photochromic, fluorescent or phosphorescent dye/dyes or a mixture of at least two of them is exposed to a predetermined number of cycles of luminous exposure to an excitation light beam, which evokes a color response of photochromic, fluorescent or phosphorescent dye/dyes or a mixture of at least two of them in the sample, whereby before and/or during and/or after each predetermined exposure to the excitation light beam the sample containing photochromic, fluorescent or phosphorescent dye/dyes or a mixture of at least two of them is exposed at least once to irradiation by an exposure light beam, due to which the dye/dyes is/are subject to fatigue loading, simultaneously, a measuring light beam, is introduced to the sample and is reflected from it, whereby the change and/or the course of the change in the characteristics of the measuring light beam reflected from the sample is monitored by a spectrometer, and from this change and/or the course of the change, the course of the color response and/or the change in the color response of the particular photochromic, fluorescent or phosphorescent dye/dyes or the mixture of at least two of them of the sample to the exposure to an excitation light beam is deduced, and thus the fatigue of this photochromic, fluorescent or phosphorescent dye/dyes or the mixture of at least two of them is also deduced.

2. The method according to claim 1, wherein the exposure light beam simulates natural daylight.

3. A device for fatigue testing of photochromic, fluorescent or phosphorescent dye/dyes or of a mixture of at least two of them, the device comprising a spherical optical integrator, in which a measuring aperture, an inlet aperture of the measuring light beam, an inlet aperture of an exposure and excitation light beams and an outlet aperture of the measuring light beam are formed, whereby in the vicinity of the measuring aperture, outside the optical integrator, is arranged space for storing and fixing a sample with the tested photochromic, fluorescent or phosphorescent dye/dyes or the mixture of at least two of them, to the inlet aperture of the measuring light beam is assigned outside the optical integrator a source of the measuring light beam, whereby in the path of the measuring light beam is located a filter of luminous radiation of excitation wavelength and a filter of IR radiation, whereas to the inlet aperture of the exposure and excitation light beams is outside the optical integrator assigned a path of the exposure light beam containing a source of the exposure light beam, and the path of the excitation light beam containing a source of the excitation light beam, whereby both these paths have a common part, which contains a beam splitter, arranged inversely, a chopper and mirror optics for introducing the exposure and excitation light beams into the inner space of the optical integrator, wherein the path of the exposure light beam contains a shutter of the exposure light beam, while the path of the excitation light beam contains a shutter of the excitation light beam and a monochromator, and to the outlet aperture of the measuring light beam is outside the optical integrator assigned a path of the measuring light beam with a spectrometer, which contains a chopper and mirror optics for introducing the measuring light beam into the sensing space of the spectrometer.

4. The device according to claim 3, wherein the path of the exposure beam includes at least one correction filter.

5. The device according to claim 3, wherein the path of the measuring light beam includes an objective.

6. The device according to claims 3, wherein the chopper in the common portion of the path of the exposure and excitation light beams and the chopper in the path of the measuring beam are interconnected by a time bond.

7. The device according to claim 3, wherein the shutter of the exposure light beam is provided with a time lock and is interconnected with the shutter of the excitation light beam by a time bond.

8. The device according to claim 3, wherein all its components are mounted in a thermostatic box.

9. The device according to claim 3, wherein the space for storing and fixing the sample is located in the thermostatic box.

10. The device according to claim 3 wherein in the vicinity of the space for storing and fixing the sample is mounted a thermostatic head.

11. The device according to claim 3, wherein at least part of the path of the exposure light beam and/or at least part of the path of the excitation light beam and/or at least part of the path of the measuring light beam is composed of an optical fiber/optical fibers.

12. The device according to claim 3, further comprising a source of reference light beam, with which a reference spectrometer is aligned.
